(19) United States
(12) Patent Application Publication
(10) Pub. No.: US 2011/0211957 A1
(43) Pub. Date: Sep. 1, 2011

(54) SELF REGULATING WIND TURBINE

(76) Inventors: Mark Folsom, Spokane, WA (US); Curt Higgins, Spokane, WA (US)

(21) Appl. No.: 12/898,862

(22) Filed: Oct. 6, 2010

Related U.S. Application Data
(60) Provisional application No. 61/308,683, filed on Feb. 26, 2010.

(51) Int. Cl. F03D 7/04; F03D 11/00

(52) U.S. Cl. 416/41; 416/89; 416/135

(57) ABSTRACT

A wind turbine for use in a wide range of wind conditions is disclosed. The wind turbine uses blade pitch change and/or blade folding to accommodate wind conditions and maintain a substantially constant speed. The blades are configured to fold in unison for balanced wind turbine operation.

### PRIORITY CLAIM AND CROSS-REFERENCE TO RELATED APPLICATION

This application claims the benefit under 35 U.S.C. §119(e)(1) of U.S. Provisional Application No. 61/308,683, filed Feb. 26, 2010, which is hereby incorporated by reference in its entirety.

### BACKGROUND

There is an increase in demand for alternate and renewable energy sources. Wind powered energy generators are becoming increasingly popular, since they harness the power of a renewable and freely available resource, the wind.

However, the wind is not a constant phenomenon. The wind may be light at times, even in areas that average heavy winds. Light winds may be insufficient to turn a wind turbine fast enough to generate a desired power output. Conversely, the wind may gust heavily at times in areas that average moderate or light winds. Heavy winds may turn a wind turbine too fast, causing mechanical damage to the turbine, or heavy winds may damage the wind turbine components (bend or break blades, push down the support tower, etc.). Additionally, the wind may vary from day to day or even hour to hour in some geographical areas, making wind inconsistent as a power source.

An electrical generator, for example, generally requires a constant speed of operation to produce electrical power that is safe and reliable. Since the wind can fluctuate between light, moderate, and heavy winds, often unpredictably, a generator that is driven by a wind turbine may not have a constant rotational speed. This may adversely affect the generator's ability to produce safe, reliable power at the desired output level. Fluctuating winds may produce power that is inconsistent in amplitude and/or phase, or tainted with surges or spikes. Such power may be unfit for most applications, or require extensive conditioning to be usable. Further, fluctuations in the rotational speed of a turbine may also damage mechanical or electrical components of the generator (such as with a sudden gust of high wind).

Many wind turbine implementations also depend upon a load being connected to an attached generator as a breaking force. When in moderate or higher winds, the turbine rotates with the power of the wind against the breaking force of the load (electrical and mechanical) from the generator. In lower winds, this type of turbine may not rotate because of the breaking force. Also, this type of wind turbine may run too fast if the load is suddenly diminished or disconnected (due to grid failure, mechanical failure, etc.), possibly destroying the wind turbine and/or the generator.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Implementations of a self regulating wind turbine are described. Specifically, wind turbines that employ an automatic blade pitch adjustment and/or an automatic blade folding adjustment are disclosed.

In one aspect, a wind turbine is described as having a plurality of blades coupled to a hub, such that each blade has at least three degrees of freedom with respect to the hub. Each blade may be configured to rotate about a central axis of the hub, and may be extendable along an axis parallel to the length of the blade. In a further embodiment, each blade may also be configured to rotate about the axis parallel to the length of the blade.

In another aspect, a wind turbine is described as having a plurality of blades and an automatic blade folding adjustment. The automatic blade folding adjustment is configured to regulate a speed of the wind turbine such that the speed is substantially constant. The automatic blade folding adjustment is operative to fold the plurality of blades in unison in response to oncoming wind exceeding a threshold wind speed. In an embodiment of the aspect, the wind turbine also includes an automatic blade pitch adjustment.

In yet another aspect, a wind turbine is described as having a plurality of blades, a pitch control stage, and a blade folding stage. The pitch control stage and the blade folding stage may operate concurrently to regulate a speed of the wind turbine, such that the speed is substantially constant. The blades are configured to extend outward along an axis parallel to the blade and to rotate about the axis parallel to the blade. The pitch control stage is configured to automatically adjust a pitch angle of each blade based on centrifugal force. The pitch control stage is configured to adjust the pitch of each blade such that the surface of each blade exposed to oncoming wind increases with an increase in the oncoming wind.

The blade folding stage is configured to automatically fold each blade in unison, using at least three mechanical pivot points, based on having a tie rod coupled to each blade. The blade folding stage is configured to automatically fold the blades in response to a wind force applied to one or more of the blades. The blade folding stage may include magnets configured to control the folding of the blades.

While described individually, the foregoing aspects are not mutually exclusive and any number of the aspects may be present in combination in a given implementation.

### BRIEF DESCRIPTION OF THE DRAWINGS

The Detailed Description is set forth with reference to the accompanying figures. In the figures, the left-most digit(s) of a reference number identifies the figure in which the reference number first appears. The same numbers are used throughout the drawings to reference like and/or corresponding aspects, features, and components.

FIGS. 1A and 1B are schematic illustrations showing an example self regulating wind turbine according to one embodiment. FIG. 1A shows the embodiment in moderate wind conditions, with the blades at their rest (un-pitched and unfolded) positions, and FIG. 1B shows the embodiment in high wind conditions, with the blades in pitched and folded positions.

FIG. 2 is a perspective view of an example self regulating wind turbine according to one embodiment.

FIG. 3 illustrates a front view of an example self regulating wind turbine according to the embodiment of FIG. 2 (blades not shown).

FIG. 4 is a perspective view of an example self regulating wind turbine according to the embodiment of FIG. 2, showing additional details (blades not shown).

FIG. 5 is a perspective view of an example self regulating wind turbine according to the embodiment of FIG. 2, the wind turbine being shown in a partially folded configuration.

FIG. 6 illustrates a side view of an example self regulating wind turbine according to the embodiment of FIG. 2.

FIG. 7 illustrates a side view of an example self regulating wind turbine according to the embodiment of FIG. 5, the wind turbine being shown in a partially folded configuration.

FIG. 8 is a section view, in perspective, illustrating details of the example self regulating wind turbine according to the embodiment of FIG. 2.

FIG. 9 is a section view, in side view, illustrating details of the example self regulating wind turbine according to the embodiment of FIG. 2.

FIG. 10 is a perspective view of an example self regulating wind turbine according to another embodiment, the wind turbine including magnets incorporated into a blade folding mechanism.

FIG. 11 is a section view, in side view, illustrating details of the example self regulating wind turbine according to the embodiment of FIG. 10.

FIG. 12 is a close-up view of the section view of FIG. 9.

FIG. 13 is another close view of the section view of FIG. 9, showing additional details of a blade support housing assembly of the embodiment of FIG. 2.

FIG. 14 is a close up perspective view of a blade support housing assembly according to an example embodiment, the view showing a blade pitch guide at a first position within a blade pitch and RPM control slot.

FIG. 15 illustrates a partial perspective view of an example self regulating wind turbine according to another alternate embodiment, comprising an alternate pitch control assembly.

### DETAILED DESCRIPTION

### Introduction

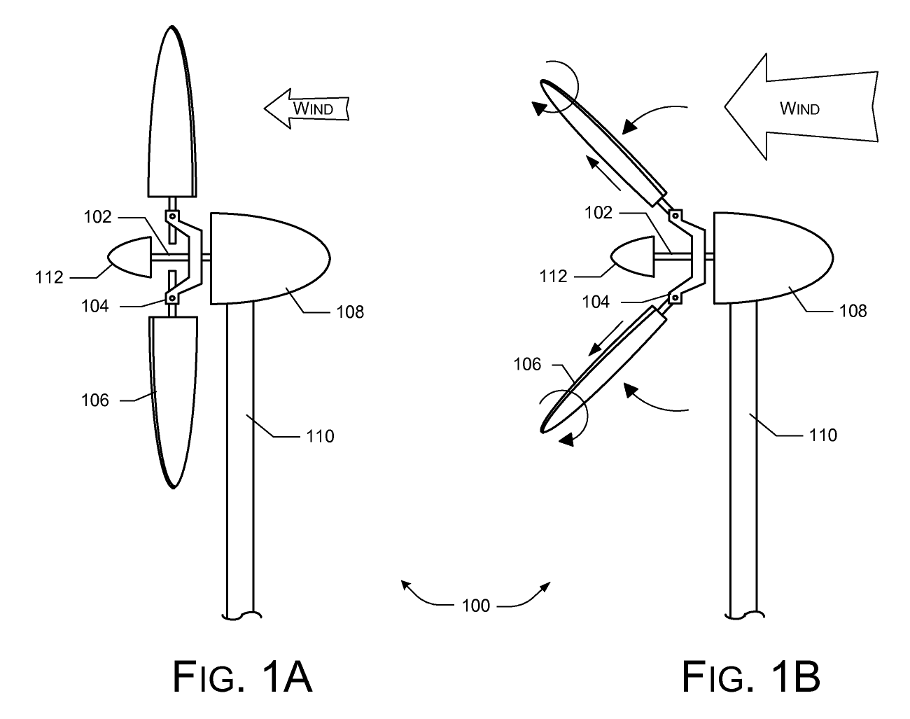

An example wind turbine 100 is disclosed, as illustrated in FIGS. 1A and 1B, for use in a wide range of wind conditions. In one embodiment, the wind turbine 100 uses a combination of blade pitch change and blade folding to accommodate wind conditions and maintain a substantially constant speed. In alternate embodiments, the wind turbine 100 may use either a blade pitch change or blade folding to accommodate wind conditions and maintain a substantially constant speed. In one example embodiment, a self regulating wind turbine 100 designed to operate at about 15 kW (maximum) maintains a steady-state speed of 140-145 revolutions per minute (RPM) over a wide range of wind conditions (e.g., from about 25 to 100 miles per hour (mph)). In alternate embodiments, depending on the implementation and design, the wind turbine 100 maintains higher or lower substantially constant speeds at other ranges of wind conditions. Factors that may affect a substantially constant speed that a wind turbine 100 is designed to operate at may include a desired power output, the size of the wind turbine and its blades, local wind conditions, and the like.

As illustrated in FIGS. 1A and 1B, an example wind turbine 100 may be comprised of a shaft 102 with a hub 104 coupled to the shaft. In an embodiment used herein to describe the wind turbine 100, the hub 104 is coupled to the shaft 102 so that the hub 104 rotates with the shaft 102, as if they were a single component. This is not a requirement of the disclosed wind turbine 100. In alternate embodiments, the hub 104 may be coupled to the shaft 102 so that they rotate partially or fully independent of each other.

In an example embodiment of the wind turbine 100, blades 106 are coupled to the hub 104, such that: (1) they fold with respect to the hub 104 and the shaft 102, and (2) each blade 106 rotates axially with respect to its attachment point to the hub 104, in addition to rotating as a group around the shaft 102 or the hub 104. In alternate embodiments, the blades 106 may be attached to another component (e.g., the shaft, an additional component, etc.). In a further embodiment, the blades 106 may fold with respect to another component (e.g., the tower support, the housing, the generator, etc.) or the blades 109 may rotate in another configuration (e.g., oblique rotation about another component such as a point on the hub.). In alternate embodiments, the blades 106 may either fold without rotation, or rotate without folding.

The example wind turbine 100 is also illustrated in FIGS. 1A and 1B as including a housing 108 which may contain a generator, a pump, or similar device intended to be driven by the wind turbine 100, a support 110 such as a tower, and the like, and a shaft cover 112. These components are for illustrative discussion, and are not specific to the wind turbine 100. Any like components may be included, added, or deleted from a wind turbine 100 without departing from the scope of the disclosure (i.e., covers, enclosures, fins, vanes, meters, indicators, and the like).

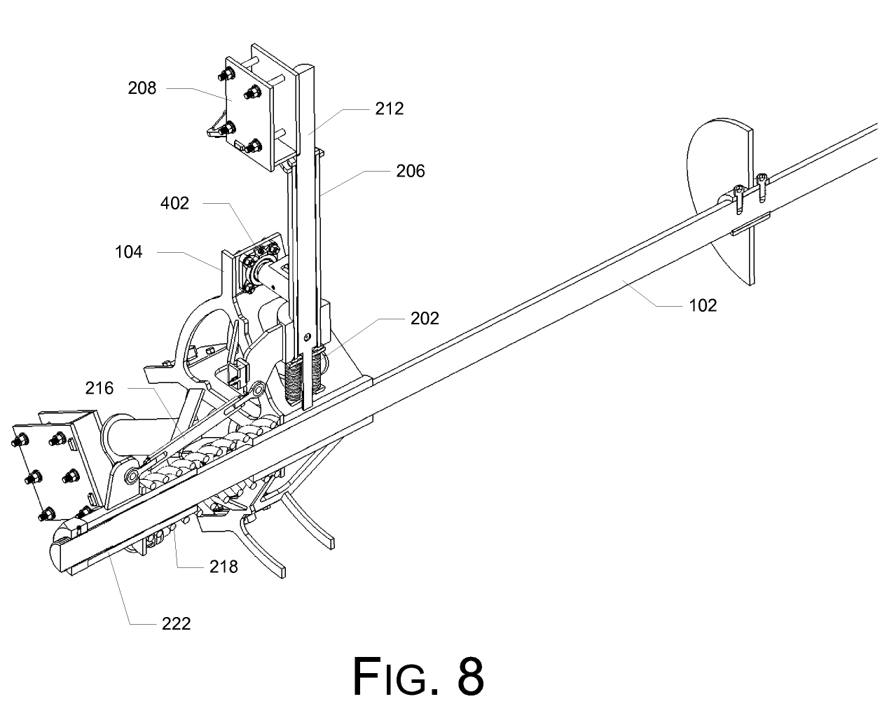

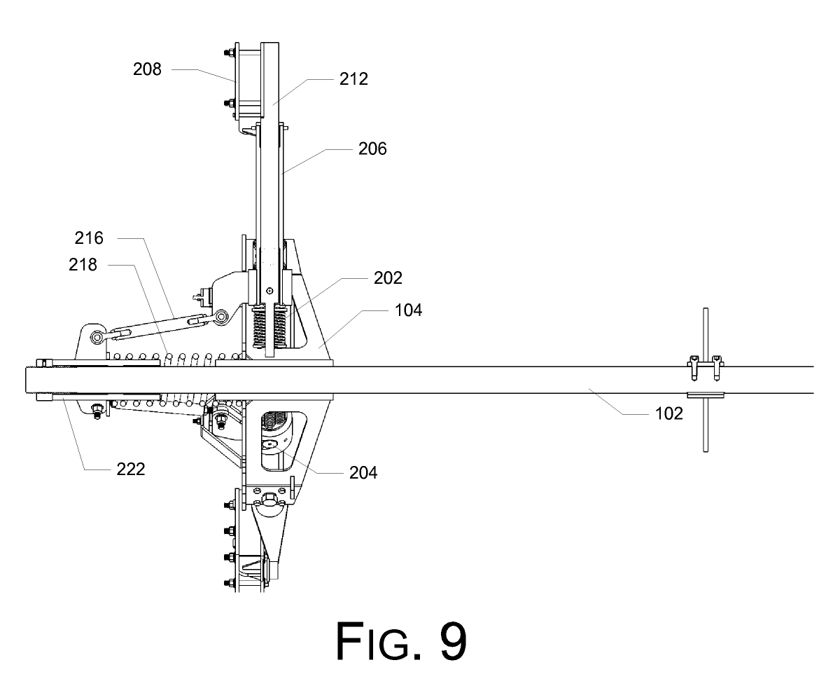

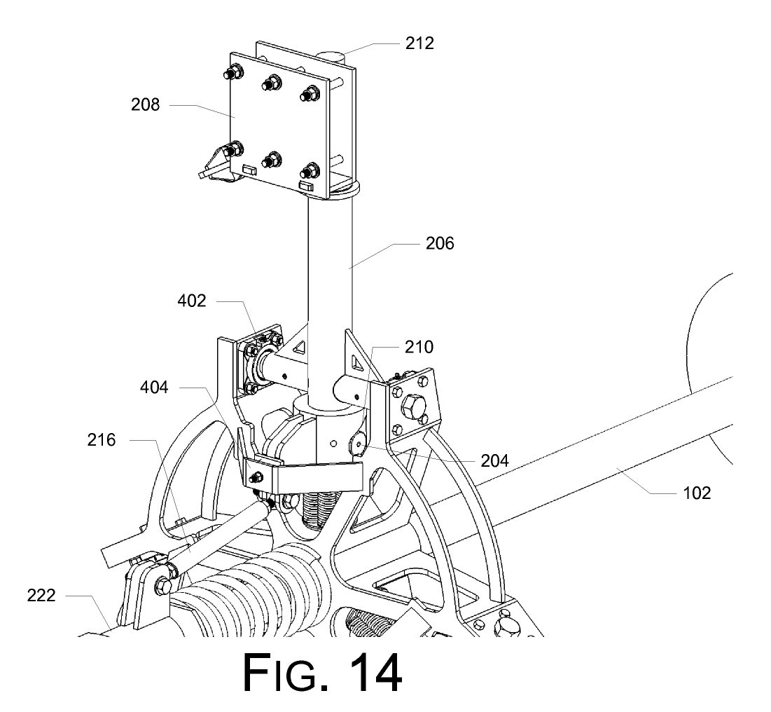

The wind turbine 100 maintains a substantially constant speed in various wind conditions primarily because the blade pitch may change and the blades 106 may fold in a progressive combination, operating together, under progressively changing wind conditions. In some instances, the pitch of the blades 106 may vary with changes in wind speed without the blades 106 folding, such as with a gradual or slight change in wind. In other instances, the blades 106 may fold independent of a blade pitch change, such as with a sudden gust of high wind. In example embodiments (as shown in FIGS. 1-15), the blade pitch changes and/or blade folding described herein are entirely mechanically actuated (i.e., without the use of a controller). In the embodiment, the mechanical design of the components, as described further, solely determines the operational characteristics of the wind turbine 100. In alternate embodiments, electronic controllers, actuators, and the like may be used on one or more components of a wind turbine 100 to determine operational characteristics.

FIGS. 1A and 1B are referred to throughout the disclosure herein. For ease of visualization, the wind turbine 100 is illustrated in FIGS. 1A and 1B as being static. However, for the purposes of discussion, the wind turbine 100 may be generally described as a dynamic rotating machine Arrows in the illustrations of FIGS. 1A and 1B represent the wind, where the smaller arrow of FIG. 1A represents a light to moderate wind (e.g., about 10-25 miles per hour (mph)) and the larger arrow of FIG. 1B represents a heavy wind (greater than 25 mph). Accordingly, while the wind turbine 100 in FIGS. 1A and 1B may be rotating about the axis of the shaft 102 due to the wind, the wind turbine 100 illustrated in FIG. 1A is shown in a state of relative rest with respect to blade folding and blade pitching mechanisms and actions (based on the light to moderate wind), while the wind turbine 100 illustrated in FIG. 1B is shown with folded and pitched blades 106 (based on the heavy wind).

A self regulating wind turbine 100 according to this disclosure may include a number of additional or alternative features that contribute to the wind turbine's performance, such as, for example: (1) blades 106 that are linked together, so that they fold in unison, maintaining balance of the wind turbine 100; (2) multiple mechanical pivot points per blade assembly, designed for a predictable and reliable folding action; (3) linear bearings for smooth operation with minimal play; (4) blades 106 that pitch so that the flat portion of the blades 106 turn to face into the wind with an increase in wind speed, such that the surface area of the blades 106 exposed to the oncoming wind increases with an increase in wind speed; and/or (5) magnets employed to provide additional control to the folding action.

### Example Self Regulating Wind Turbine

The following description refers to the drawings shown in FIGS. 1-15. Several embodiments of self regulating wind turbines 100 are described. Descriptions of the embodiments include examples of materials, types of fabrication, and dimensions. However, the descriptions are for ease of understanding and are not intended to be limiting. Other suitable materials, types of fabrication, and dimensions may be used to construct a self regulating wind turbine 100 without departing from the scope of this disclosure.

Referring to FIGS. 1A and 1B, in one example, a shaft 102 is coupled to a hub 104 on one end of the shaft 102, and a generator device (may be enclosed in housing 108) on the other end of the shaft 102. Blades 106 are mechanically coupled to the hub 104. Thus, as the blades 106 turn in the wind, the hub 104 rotates, thereby rotating the shaft 102, and thus rotating the generator device coupled to the shaft 102. In one example, the generator device is a device for generating electricity. However, the generator device may be a pump, flywheel, heater, or other device for translating rotational energy to another form of energy (e.g., mechanical, thermal, and/or electrical energy).

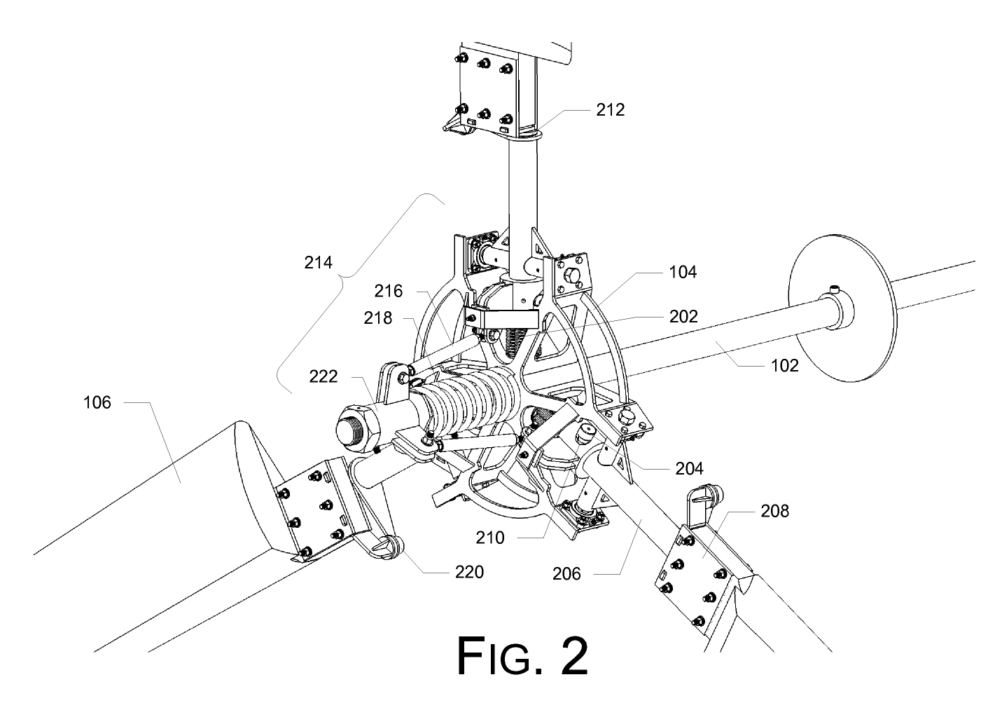

In one example, composite or fiberglass blades 106 may be used. In other embodiments, the blades 106 may be constructed of other materials with desired weight and strength characteristics (e.g., aluminum, steel, fiberglass, composites, etc.). Three blades 106 may be used for a wind turbine 100, for example, as shown in the illustrations of FIGS. 2, 4, and 6. However, in other embodiments, other numbers of blades 106 may be used (e.g., 2, 4, 5, etc.).

In one embodiment, as shown in the illustration of FIGS. 1A and 1B, the shaft 102 is arranged horizontally with respect to the wind turbine 100. In other embodiments, the shaft 102 may be arranged vertically, or some other arrangement suitable for turning a generator device (e.g., with the provision of a gear box, drive belt, universal joint, etc.). The shaft 102 may be constructed of a hardened metal, for example, and it may be precision ground or similarly fabricated for preset tolerances.

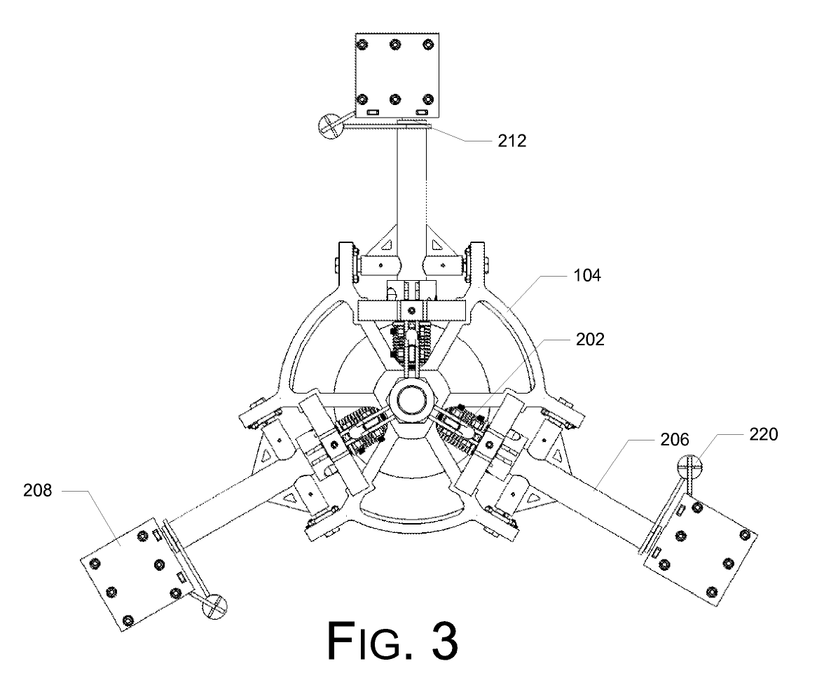

In one example, as illustrated in FIGS. 2 and 3, the hub 104 is a rigid frame coupled to the shaft 102, such that the shaft 102 rotates with the hub 104. The hub 104 may be constructed of a rigid material such as stamped or formed metal. In some examples, the hub 104 may be made of steel or aluminum. The blades 106, as well as the pitch control mechanisms and folding mechanisms, described below, may be coupled to the hub 104.

### Pitch Control Mechanism

In one embodiment, as illustrated in FIGS. 2, 4, and 5, a pitch control mechanism includes a blade pitch spring 202, a blade pitch guide 204, a blade support housing 206, a blade mount assembly 208, a blade pitch and rotation per minute (RPM) control slot 210 (also referred to as a blade pitch control slot), and a blade pitch control shaft 212. In other embodiments, additional components may be included, or some of the listed components may be omitted, while remaining within the scope of this disclosure. Further, in alternate embodiments, other components may be substituted for the ones listed herein, to provide a similar pitch control function.

In one example, the blade pitch spring 202 governs the blade pitch by pulling on the rotating blade 106 through the blade pitch control shaft 212. The blade pitch spring 202 is illustrated as one or more coil springs; however, other devices may be employed as a blade pitch spring 202 (e.g., Belleville washers, torsion springs, etc.) including various combinations of the same. The blade pitch control shaft 212 is otherwise free to move linearly (a predetermined extent) back and forth through the blade support housing 206 (along an axis parallel to the length of the blade 106), and to rotate (a predetermined extent) within the blade support housing 206 (about the axis parallel to the length of the blade 106). As the rotating blades 106 increase in speed, each blade 106 has a tendency to move outward from the hub 104 (as shown in FIG. 1B) based on centrifugal force acting on the blade 106, pulling the blade pitch control shaft 212 with the blade 106. The blade pitch spring 202 applies a centripetal force to the blade 106, through the blade pitch control shaft 212, biasing the blade 106 toward the hub 104.

Depending on the spring characteristics of the blade pitch spring 202, the blade pitch spring 202 may compress, allowing the blade pitch control shaft 212 to move linearly outward (away from the hub 104) through the blade support housing 206, as the blade 106 increases in speed. In one example, the blade pitch guide 204 and the blade pitch and RPM control slot 210 provide control to the movement of the blade pitch control shaft 212, and thus, the movement of the blade 106.

In an embodiment, the pitch of the blade 106 changes as the blade 106 moves outward away from the hub 104. This is due to the blade pitch control shaft 212 rotating within the blade support housing 206 as guided by the blade pitch guide 204 and the blade pitch and RPM control slot 210. As shown in FIGS. 2, 4, 10, and 14, the blade pitch and RPM control slot 210 may be shaped in a curve, such that the blade pitch control shaft 212 rotates as the blade pitch control shaft 212 moves outward within the blade support housing 206, as guided by the blade pitch guide 204. For example, the blade may pitch in one direction when moving outward (away from the hub 104), and pitch in the opposite direction when moving inward (toward the hub 104), based on the blade pitch guide 204 and the shape of the blade pitch and RPM control slot 210.

The shape of the blade pitch guide 204 and the blade pitch and RPM control slot 210 may vary in alternate embodiments, determining the pitching action of the blade as it extends and retracts with the blade pitch control shaft 212. In one embodiment, the shape of the blade pitch and RPM control slot 210 is generally “backslash-shaped.” In alternate embodiments, the shape of the blade pitch and RPM control slot 210 is generally “C-shaped,” “S-shaped,” or “L-shaped.” Further, other shapes of the blade pitch and RPM control slot 210 are contemplated, with each providing a different pitch control dynamic in conjunction with the blade pitch guide 204 and the blade pitch spring 202. Use of different blade pitch and RPM control slot 210 shapes to control pitch dynamics may enhance application of the wind turbine 100 in different climates or geographical areas. For example, one shape of blade pitch and RPM control slot 210 may provide a quicker pitch transition than another, or a more linear pitch transition than another.

The blade pitch and RPM control slot 210 determines a limit whereby each blade 106 may extend along the axis parallel to the length of the blade 106 and a limit whereby each blade 106 may rotate about the axis parallel to the length of the blade 106. The blade pitch guide 204 controls the pitch angle of each blade 106 based on the blade pitch control slot 210. The blade pitch guide 204 and the blade pitch and RPM control slot 210 may be constructed of hardened materials, for example hardened steel, for longevity and precise operation. In alternate embodiments, the blade pitch guide 204 and/or the blade pitch and RPM control slot 210 may incorporate bearings to facilitate smooth operation. The location or position of the blade pitch guide 204 and the blade pitch and RPM control slot 210 may vary with respect to the blade support housing 206 with alternate embodiments, while maintaining the overall pitch control and folding actions.

In one embodiment, as shown in FIGS. 2-5, one or more bumpers 220 may be employed to apply tension or pressure to the pitch control mechanism to reduce or prevent slack in various components of the pitch control mechanism. In alternate embodiments, the bumpers 220 may be located at various locations. In the example embodiment illustrated in FIGS. 2-5, bumpers 220 are located at the blade support housing 206 and the blade mount assembly 208. In this example, the bumpers 220 apply pressure to the blade support housing 206 and the blade mount assembly 208, reducing, if not eliminating slack movement, and thus vibration associated with the pitch control mechanism. In alternate embodiments, other devices may be employed to control vibration (i.e., springs, keepers, dampers, etc.).

### Blade Folding Mechanism

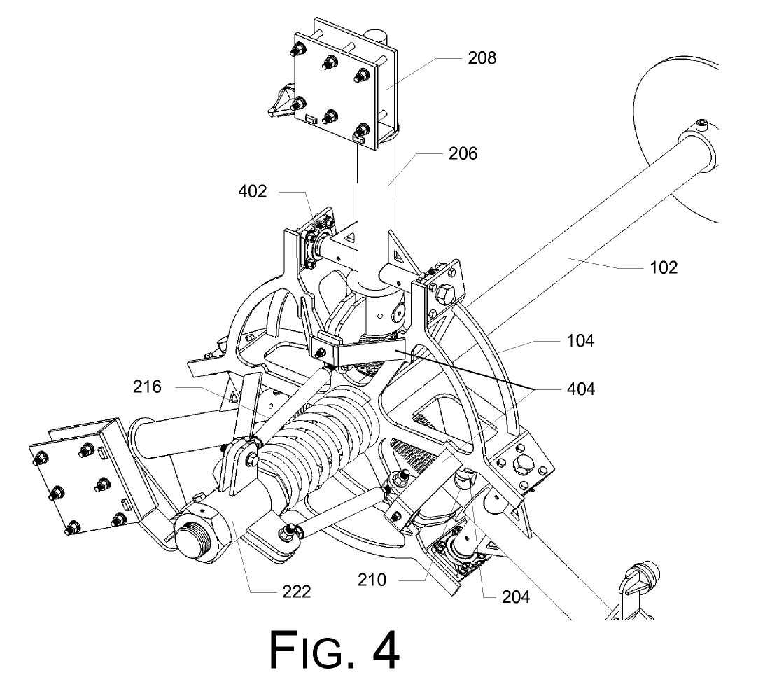

In one embodiment, as shown in FIGS. 4-12, a blade folding mechanism 214 includes the blade support housing 206, tie rods 216, one or more shaft springs 218, and a collar assembly 222. In other embodiments, additional components may be included, or some of the listed components may be omitted, while remaining within the scope of this disclosure. Further, in alternate embodiments, other components may be substituted for the ones listed herein, to provide a similar blade folding function.

In one embodiment, as shown in FIGS. 4-6 and 9, the blade support housing 206 connects the blade 106 (as coupled to the blade pitch control shaft 212) to the hub 104 through a flange bearing 402 and a tie rod 216. For example, the blade 106 may be attached to the blade pitch control shaft 212 through a blade mount assembly 208. The blade mount assembly 208 may be in various forms or shapes to perform this function. The flange bearing 402 is a bearing upon which the blade support housing 206 pivots as part of the blade folding action of the blade folding mechanism 214.

In one example, the tie rod 216 is coupled to the collar assembly 222 on one end, and the blade support housing 206 on the other end. The collar assembly 222 moves linearly inward (toward the hub 104) during folding of the blades 106. In one example, all blades 106 are coupled to the folding mechanism 214 through a tie rod 216, such that each of the blades 106 folds in unison. The shaft spring 218 compresses between the collar assembly 222 and the hub 104 during blade folding, resisting the folding action and attempting to move the blade folding mechanism 214 (including the collar assembly 222) to the unfolded rest position.

In an embodiment, as shown in FIG. 4, one or more dampers 404 may be employed to apply tension or pressure to the blade folding mechanism 214 to reduce or prevent slack in various components of the blade folding mechanism 214 and to reduce or eliminate vibration in the components. In alternate embodiments, the dampers 404 may be located at various locations. In the example embodiment illustrated in FIG. 4, dampers 404 are located on the hub 104, and apply pressure or tension to the blade support housing 206. For example, the dampers 404 and/or the blade support housing 206 may be configured such that the dampers 404 apply pressure to the blade support housing 206 as the blade support housing 206 transitions from the unfolded rest position to a folded position, reducing, if not eliminating slack movement, and thus vibration associated with the blade folding mechanism 214. In some embodiments, the dampers 404 and/or the blade support housing 206 may be configured to include detents, or the like, to increase vibration reduction effectiveness at predetermined locations within the transition. For example, the blade support housing 206 may be configured to include detents at least at the unfolded rest position and the fully-folded position. In alternate embodiments, other devices may be employed to control vibration (i.e., springs, keepers, bumpers, etc.).

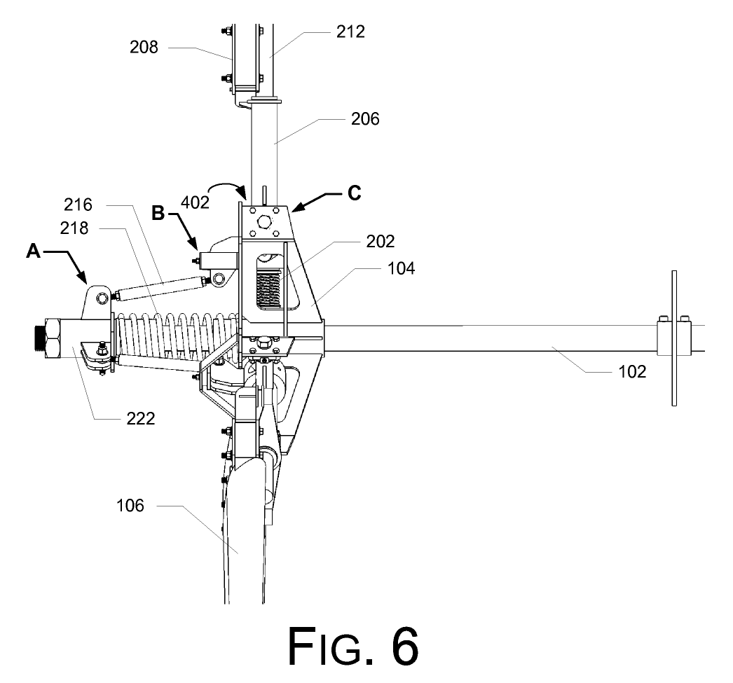

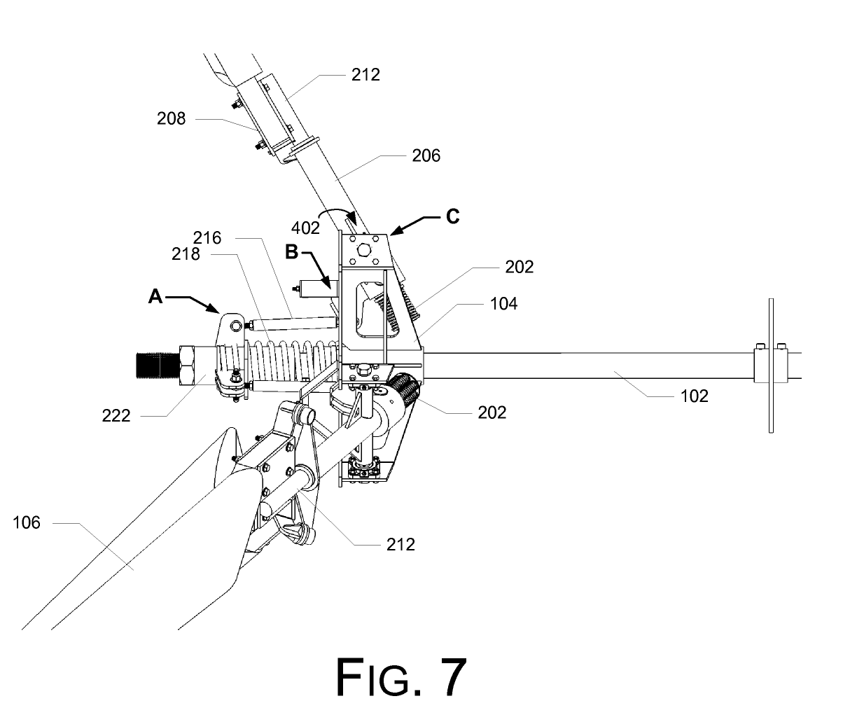

During folding, each blade assembly pivots at least in three places: (A) a collar assembly 222/tie rod 216 joint, (B) a blade support housing 206/tie rod 216 joint, and (C) a flange bearing 402 joint (as can be seen in FIGS. 6-7). The location of these joints (A, B, and C) is shown in the figures as an example. In other embodiments, other locations of the joints are possible, while maintaining the folding action functions described here and below. In alternate embodiments, each blade assembly may pivot in fewer or additional places while maintaining the blade folding function described herein.

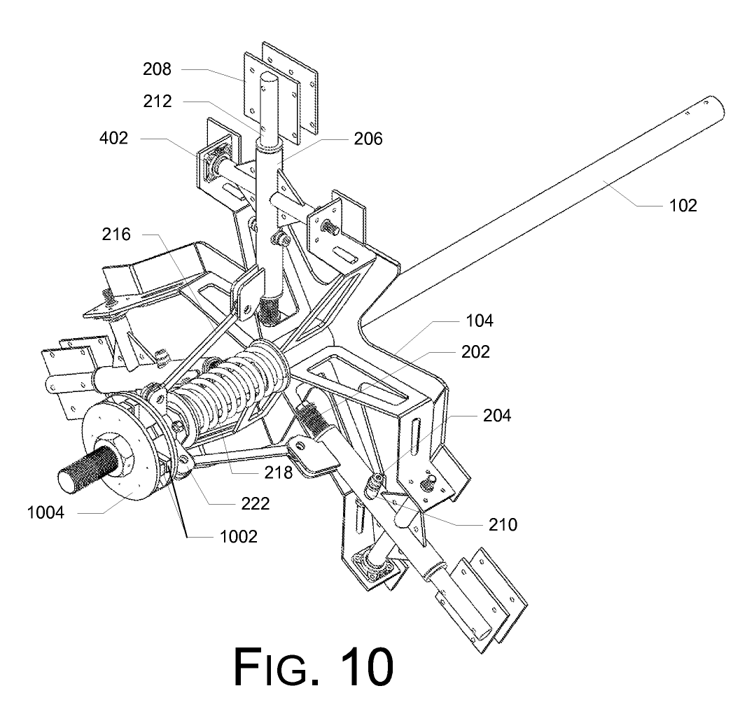

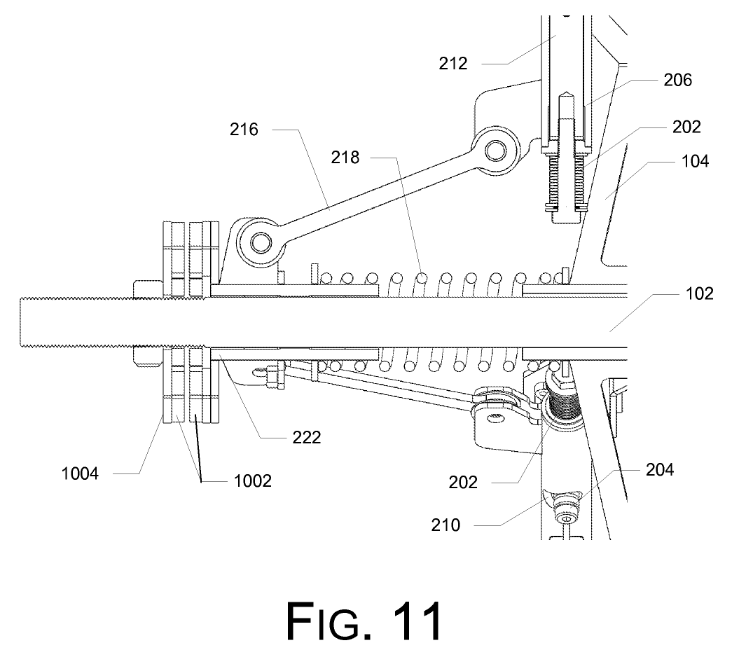

In one embodiment, as illustrated in FIGS. 10-11, a collar assembly 222 may include magnets 1002 as part of the blade folding mechanism 214. In one embodiment, magnets 1002 may be located on facing surfaces of the collar assembly 222 and an outer collar assembly 1004. In alternate embodiments, the magnets 1002 may assist the shaft spring 218 to control the folding action, by providing an attracting force between the collar assembly 222 and the outer collar assembly 1004. In alternate embodiments, the magnets 1002 may provide other features, as discussed in a later section.

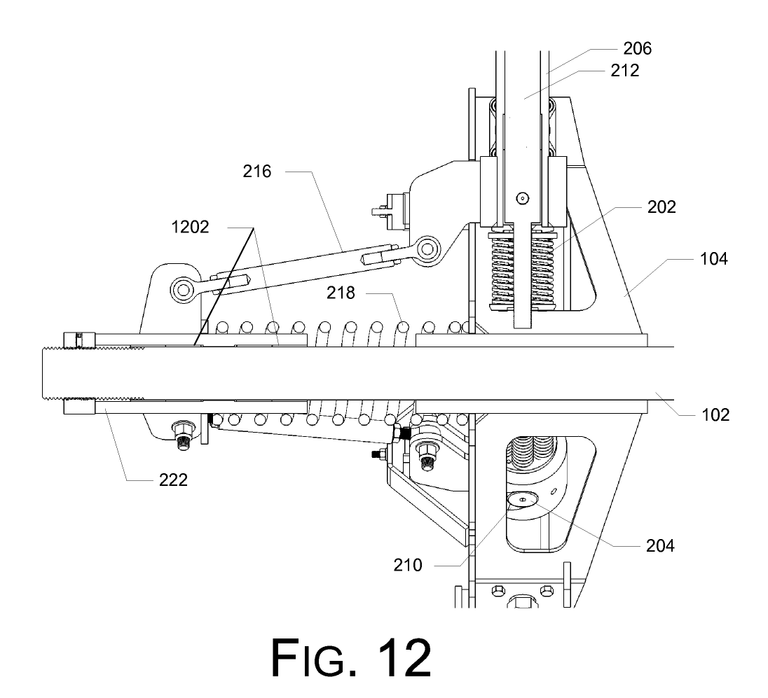

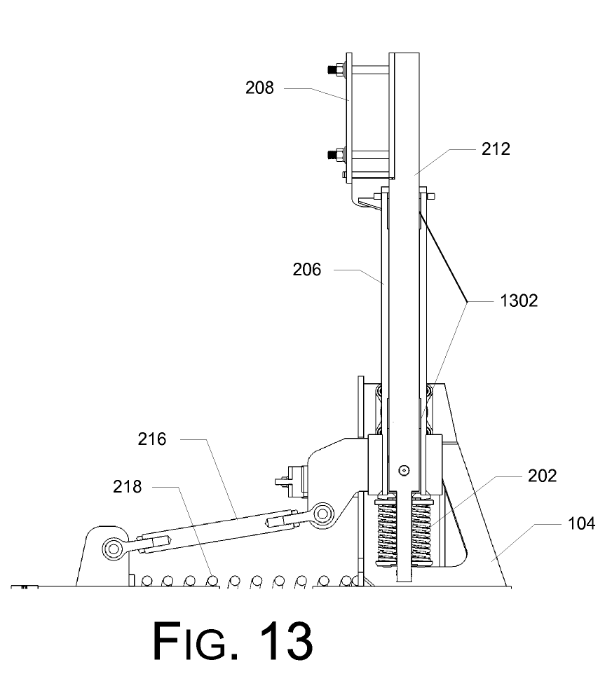

Additionally, as shown in FIGS. 12 and 13, in some embodiments, linear bearings 1202 and 1302 may be employed inside the collar assembly 222 and the blade support housing 206, respectively. Linear bearings 1202 and 1302 may be located between mechanical parts that generally slide against each other (e.g., the shaft 102 and the collar assembly 222, and the blade pitch control shaft 212 and the blade support housing 206). Linear bearings 1202 and 1302 may reduce or eliminate play between the moving parts, and contribute to smoother folding and pitching actions and operations. Linear bearings 1202 and 1302 may be constructed of oil impregnated plastics, or similar materials having desired friction and wear characteristics. In other embodiments, other types of bearings may be employed. Further, in still other embodiments, linear bearings may be employed at additional locations.

### Example Operation

When the wind turbine 100 is at rest, or functioning under light or moderate winds (i.e., approximately 0 to 25 mph), the blades 106 are generally perpendicular to the shaft 102, as illustrated in FIGS. 1A, 2, 4, 6, and 8. The “wind” arrow shown in FIG. 1A indicates a light or moderate wind. Also, in this state, the blades 106 may be in a high torque pitch position (power position). A blade 106 in a high torque pitch position may start rotating, or maintains rotation, with lighter winds (i.e., approximately 0 to 5 mph). For example, the face of the blade 106 (at the widest part of the blade) may be at a pitch of about 26 degrees to the oncoming wind. In some embodiments, a blade 106 with a changing pitch from end to end may be used, where the widest part of the blade 106 is at the end attached to the blade mount assembly 208, and the blade pitches and gets narrower toward the end or tip of the blade. For example, the blade 106 may have a pitch change of about 18 degrees from the widest part of the blade to the tip of the blade. In other embodiments, other blades 106 having different pitch changes may be used.

Based on the shape and size of the blades 106, the blades 106 rotate slowly with light wind, and rotate faster as the wind increases. For example, the blades 106 may begin to rotate with about 5 mph wind in some embodiments. In other embodiments, the blades 106 may begin to rotate with lesser or greater wind speeds. With moderate winds, the blades 106 will rotate with a substantially constant speed. In one example embodiment of a self regulating wind turbine 100, the blades 106 will rotate at a substantially constant speed of about 140-145 RPM with blades 106 that are about 12 feet long, are about 16 inches wide at their widest point, and have a pitch change of about 18 degrees from the widest part of the blade to the tip of the blade, when a wind of about 25 mph is present. In other examples, different substantially constant speeds and larger or smaller ranges of speeds may be used, depending on local wind speed averages, power generation requirements, blade configuration and materials, and the like. In other examples, blades 106 with a greater surface area may be used to generate more torque from less wind, which may result in rotation startup and/or faster rotation at lower wind speeds. A person having skill in the art will appreciate the effects of various wind conditions on start-up rotation, steady-state rotation speed, and the like, when one or more properties of the blades 106 is changed (e.g., materials, length, width, pitch change, etc.). Wind turbines having blades 106 with such various properties remain within the scope of the present disclosure.

Once the blades 106 are rotating at a substantially constant speed (again, based on their size and shape, etc.) they will continue to rotate at that speed with varying wind conditions, unless the wind drops below a sustainable level for more than a brief period of time. One embodiment of a self regulating wind turbine 100 is configured to maintain the substantially constant speed even in high wind conditions. For example, the blades 106 of the wind turbine 100 may rotate at a nearly constant 140-145 RPM in wind of about 25 to 100 mph wind or greater. This is due to the pitch control and folding actions described below. In alternate embodiments, the blades 106 may rotate at nearly constant speeds with lower or higher wind speeds.

### Pitch Control Action

When the velocity of blade rotation increases, generally due to an increase in wind, the mass of the blades 106 causes the blades 106 to tend to move outward (as shown in FIG. 1B), extending each blade 106 and pulling each blade pitch control shaft 212 outward from the hub 104. Referring to FIG. 2, in one embodiment, the outward movement of the blade pitch control shaft 212 is countered by the blade pitch spring 202. If the centrifugal force of a blade 106 moving outward overcomes the spring characteristics of the blade pitch spring 202, then the blade pitch spring 202 compresses, allowing the blade pitch guide 204 to follow the blade pitch and RPM control slot 210 as the blade pitch control shaft 212 moves outward within the blade support housing 206. The movement of the blade pitch control shaft 212, and the blade pitch guide 204 within the blade pitch and RPM control slot 210 is illustrated in FIG. 10 (showing the blade pitch guide 204 at a starting or rest position within the blade pitch and RPM control slot 210) and FIG. 11 (showing the blade pitch guide 204 midway within the blade pitch and RPM control slot 210). In one example, this movement causes the blade 106, which is coupled to the blade pitch control shaft 212, to rotate and change its pitch relative to the wind. This function or mechanism contributes to controlling the RPMs, or rotational velocity, of the hub 104 assembly.

In one embodiment, as the blade's pitch changes relative to the wind, the blade 106 becomes less efficient. In one example, the blade 106 may pitch up to about 26 degrees during its pitch change with increasing wind speed. This has the effect, for example, of positioning the widest portion of the blade at up to about zero degrees (or flat) into the oncoming wind. FIG. 1B shows one example of a blade 106 that has pitched due to high winds (or fast rotation of the blades 106 about the shaft 102). Further, a blade pitch change may have the effect, for example, on a blade that changes pitch over the length of the blade, of positioning the tip of the blade 106 at up to about −18 degrees into the wind, creating a reverse torque on the hub 104. Thus, the pitch change action may slow the rotation of the blades 106 and the hub 104.

To control pitch change, some blade pitch may be designed to occur with little outward travel of the blade 106. In one example, the linear travel of the blade pitch control shaft 212 within the blade support housing 206 during pitch change movement may be about ⅜ inch. In other embodiments, blade pitch may be designed to occur more gradually, using a longer linear travel of the blade 106, or designed to occur more rapidly, using a shorter linear travel.

In one example, the inner surface of the blade support housing 206 and the outer surface of the blade pitch control shaft 212 may be smooth. Further, as illustrated in the example of FIG. 13, a linear bearing 1302 may be inserted between the two surfaces at one or more locations to reduce friction and to promote a smooth operation. For example, the linear bearings 1302 may be oil impregnated plastic bushings, or the like.

In an alternate embodiment, the inner surface of the blade support housing 206 and the outer surface of the blade pitch control shaft 212 may be rifled to control the motion of the blade pitch control shaft 212 within the blade support housing 206. In a further embodiment, a torsion spring may be employed, where the torsion spring applies pressure to the blade pitch guide 204. For example, the torsion spring may control the operating point of the pitch control action. In alternate embodiments, as discussed above, the blade pitch and RPM control slot 210 may be generally “backslash-shaped,” “L-shaped,” “C-shaped,” “S-shaped,” or the like, creating other techniques of controlling the dynamic of the pitch control action (i.e., controlling the operating point, the pitch change transition action, delay, etc.).

As mentioned above, the combined effects of blade pitch change may consequently slow the rotation of the hub 104. As the velocity of rotation decreases, the centrifugal force on the blades 106 decreases, the blade pitch control shaft 212 is pulled back inward (toward the hub 104) by the blade pitch spring 202, and the pitch of the blade 106 reverses according to the blade pitch guide 204 as it follows the blade pitch and RPM control slot 210.

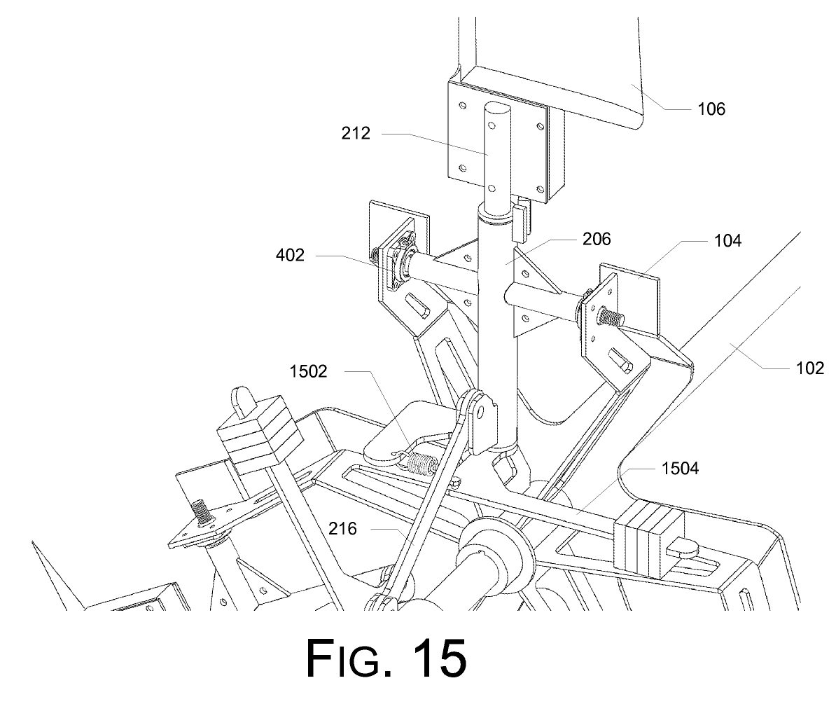

FIG. 15 shows an alternate method of controlling pitch change action. In the embodiment illustrated in FIG. 15, a blade pitch spring 1502 may be attached to a weighted arm 1504. The weighted arm 1504 is mechanically coupled to the blade pitch control shaft 212, such that the rotation of the blade pitch control shaft 212 (which determines blade 106 pitch) is controlled by the tension of the blade pitch spring 1502 in one rotational direction, and the weight of the weighted arm 1504 in the other rotational direction. Tuning the pitch control action may be effected by changing the spring characteristics of the blade pitch spring 1502 in combination with adding or removing weight from the weighted arm 1504.

### Blade Folding Action

In addition to the pitch change action described above, the wind turbine 100 may include a blade folding action (as shown in FIGS. 1, 5, and 7). In an example embodiment, as illustrated in FIGS. 1A and 1B, the wind turbine 100 may be constructed such that the generator device is upwind (within housing 108, for example), and the blades 106 are downwind, so that the blades 106 fold away from the generator device during higher wind. In other embodiments, the wind turbine 100 may be constructed using other configurations that make use of the blade folding action. For example, as illustrated in FIGS. 1A and 1B, the wind turbine 100 may be mounted on a tower 110 or similar structure, where the blades 106 fold away from the tower 110 or structure.

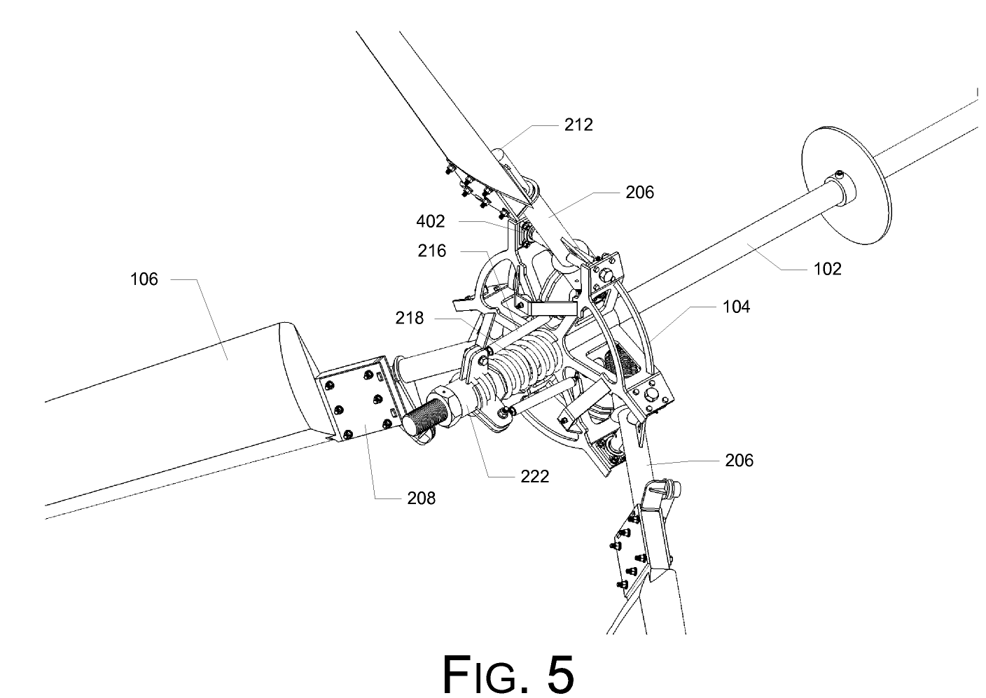

Referring to FIG. 1B, as the blades 106 are pitched, and positioned such that greater blade surface area is exposed to the oncoming wind (due to the pitch change action described above), the wind acting on the blades 106 may have the tendency to push the blades 106 into a folded configuration. As illustrated in FIGS. 1-11, the blade folding mechanism 214 allows all of the blades 106 to fold in unison away from the wind. The blades 106 fold together since they are attached by common linkages (tie rods 216) to the collar assembly 222, which moves linearly towards the hub 104 during folding. As shown in FIGS. 5 and 7, this causes the collar assembly 222 to compress the shaft spring 218 against the hub 104, which resists the folding action. The blades 106 fold when the wind exceeds a predetermined wind speed and the force of wind against the blades 106 overcomes the spring compression characteristics of the shaft spring 218.

In one example, as shown in FIGS. 2-9, the blade support housing 206 pivots on the flange bearings 402 attached to the hub 104 during folding, due to the blade pitch control shaft 212 and the blade 106 folding away from the wind (see FIGS. 5 and 7). In one example, as shown in FIG. 5, a blade 106 folding away from the wind comprises the blade folding toward the central (rotational) axis of the hub 104. As is illustrated in FIG. 1B, a result of folding the blades 106 away from the wind is a decreasing footprint into the wind. This again, may cause the blades 106 to be less efficient in the wind, slowing down the rotation of the hub 104. As the force of the wind is reduced on the blades 106, either due to the reduction in footprint (from the folding) or due to a decrease in wind, the shaft spring 218 pushes the collar assembly 222 outward along the shaft 102, and away from the hub 104, thereby re-extending the blades 106.

While less fold may be effective to maintain constant speed, in one example, the blades 106 may fold up to about 30 degrees from their rest position in high wind conditions. In other embodiments, the blades 106 may fold up to greater or lesser degrees in high wind conditions.

Referring to FIGS. 10-11, in one alternate embodiment, magnets 1002 located on the facing surfaces of the collar assembly 222 and an outer collar assembly 1004 may be used to assist in controlling the folding action. For example, the magnets 1002 may help to determine the amount of wind needed before folding occurs (combination of the magnets 1002 and the shaft spring 218), or the magnets 1002 may assist in returning the collar assembly 222 to its rest position.

In an alternate embodiment (not shown), the magnets 1002 are electromagnets. For example, the magnets 1002 may be controllable (e.g., to regulate energy generated, to avoid spikes to the grid, etc.) by a manually or automatically operated controller, to attract the collar assembly 222 to the outer collar assembly 1004 (extending the blades 106), to repel the collar assembly 222 from the outer collar assembly 1004 (folding the blades 106), or to be in a non-magnetic state (where extending/folding the blades 106 is a function of the shaft spring 218). In alternate embodiments, a controller for the magnets 1002 may be remotely located (e.g., at a remote utility site), or located locally for on-site control of blade folding and extension.

The two functional actions of blade pitch change and blade folding work together to govern the overall function of the wind turbine 100, and to allow it to operate at a substantially constant speed in varying wind conditions. At varying wind speeds, a measure of pitch change may occur and a measure of blade folding may occur, both acting concurrently, such that a substantially constant rotational velocity is maintained. The blade pitch and blade folding automatically adjust with changes in wind speed, as described above, to maintain the substantially constant speed under a wide range of wind conditions.

### Example Features

One benefit of the blade pitch change and blade folding actions is that it allows for a wider blade 106 to be used. A wider blade 106 is beneficial for lower start up speed, and more torque at lower speeds. The pitch and fold functions also allow the turbine 100 to function safely in high winds by changing the blade pitch to control RPMs and folding to decease wind load. Not only is the wind turbine 100 more efficient in low and high winds but its folding action also may extend the life of the generation system, as the blades 106, the tower 110, and the tower foundation may experience decreased stress by allowing the wind to be deflected off the folded blades 106. This may be the case when a sudden gust of wind blows the blades 106 into a folded position momentarily. During a sudden wind gust such as that, the blades 106 may fold without the blades 106 changing pitch. Such a sudden gust of wind may cause damage to blades (wider blades particularly) if they are used on a system without folding capability.

Further, since the wind turbine 100 is configured such that all of the blades 106 fold in unison, the balance of the turbine 100 may be greatly improved. A system where each blade may fold individually could produce an unbalanced rotation of the hub, causing premature wear or damage to the hub, shaft, generator, tower and/or foundation. A balanced rotation as is achieved by the wind turbine 100 may improve the top speed of rotation, and may also extend the life of the components.

The wind turbine 100 disclosed herein need not rely on a load to be connected to the generator device for a breaking force. The mechanical actions of the pitch control action and the blade folding action as described above allow the wind turbine 100 to maintain a constant safe speed, even without a load. In alternate embodiments, the pitch control action may operate independently of the folding action, the folding action may operate independently of the pitch control action, or the pitch control action and the folding action may act concurrently. Should the rotation of the wind turbine 100 rapidly increase for any reason, including grid failure, load failure, high winds, and the like, the pitch control action and/or the folding action will operate as discussed above to slow the rotation. This comprises an additional safety feature that may prevent the wind turbine 100 from self-destructing in the event of a grid failure, a load failure, high winds, or the like.

### CONCLUSION

While various discreet embodiments have been described throughout, the individual features of the various embodiments may be combined to form other embodiments not specifically described. The embodiments formed by combining the features of described embodiments are also self regulating wind turbines 100.

What is claimed is:

1. A wind turbine comprising:
a rotatable hub;
a plurality of blades configured to rotate about a central axis of the hub, the plurality of blades coupled to the hub such that each blade has at least three degrees of freedom with respect to the hub, such that:
each blade is extendable along an axis parallel to a length of the blade,
each blade is configured to rotate about the axis parallel to the length of the blade, and
each blade is configured to fold in unison toward the central axis of the hub.

2. The wind turbine of claim 1, wherein a surface area of each of the plurality of blades exposed to an oncoming wind increases with an increase in the oncoming wind.

3. The wind turbine of claim 2, further comprising a weighted arm configured to bias the rotation of each of the plurality of blades about the axis parallel to the length of the blade.

4. The wind turbine of claim 1, further comprising an automatic blade pitch adjustment configured to automatically adjust a pitch angle of each of the plurality of blades to apply a reverse torque on the rotation of the plurality of blades.

5. The wind turbine of claim 4, wherein the automatic blade pitch adjustment operates concurrently with an automatic blade folding adjustment to regulate the speed of the wind turbine such that the speed is substantially constant.

6. A wind turbine comprising a plurality of blades and an automatic blade folding adjustment, the blade folding adjustment configured to regulate a speed of the wind turbine such that the speed is substantially constant,
wherein the automatic blade folding adjustment is operative to fold the plurality of blades in unison in response to oncoming wind.

7. The wind turbine of claim 6, wherein each of the plurality of blades is configured to fold in unison based on a wind force applied to at least one of the plurality of blades.

8. The wind turbine of claim 6, wherein each of the plurality of blades is configured to extend along an axis parallel to a length of the blade, based on a centrifugal force applied to the blade.

9. The wind turbine of claim 6, wherein each of the plurality of blades is configured to rotate about an axis parallel to a length of the blade.

10. The wind turbine of claim 6, further comprising at least three mechanical pivot points associated with a folding of each of the plurality of blades.

11. The wind turbine of claim 10, further comprising a tie rod associated with each of the plurality of blades, wherein the tie rod provides at least two of the at least three mechanical pivot points associated with the folding of each of the plurality of blades.

12. The wind turbine of claim 6, further comprising a shaft spring operatively coupled to the plurality of blades and configured to bias the folding of the plurality of blades.

13. The wind turbine of claim 6, further comprising one or more magnets operatively coupled to the automatic blade folding adjustment, the one or more magnets configured to control the folding of the plurality of blades.

14. The wind turbine of claim 13, wherein the one or more magnets are electromagnets.

15. The wind turbine of claim 6, further comprising an automatic blade pitch adjustment configured to automatically adjust a pitch angle of each of the plurality of blades.

16. The wind turbine of claim 15, wherein the automatic blade pitch adjustment operates concurrently with the automatic blade folding adjustment to regulate the speed of the wind turbine such that the speed is substantially constant.

17. The wind turbine of claim 15, wherein the automatic blade pitch adjustment is configured to automatically adjust a pitch angle of each of the plurality of blades such that a surface area of each of the plurality of blades exposed to oncoming wind increases with an increase in the oncoming wind.

18. The wind turbine of claim 15, wherein the automatic blade pitch adjustment is configured to automatically adjust a pitch angle of each of the plurality of blades to apply a reverse torque on the rotation of the plurality of blades.

19. The wind turbine of claim 15, further comprising a blade pitch control slot associated with each of the plurality of blades, the blade pitch control slot configured to determine a limit whereby each of the plurality of blades may extend along an axis parallel to the length of the blade and a limit whereby each of the plurality of blades may rotate about an axis parallel to the length of the blade.

20. The wind turbine of claim 19, further comprising a blade pitch guide operatively coupled to the blade pitch control slot, the blade pitch guide configured to control the pitch angle of each of the plurality of blades based on the blade pitch control slot.

21. The wind turbine of claim 15, further comprising a blade pitch spring operatively coupled to each of the plurality of blades, the blade pitch spring configured to bias the extension of each of the plurality of blades.

22. A wind turbine comprising:
a plurality of blades coupled to a hub configured to rotate about a central axis of the hub, each blade being configured to extend along an axis parallel to a length of the blade, based on a centrifugal force applied to the blade, and to rotate about the axis parallel to the length of the blade, wherein the plurality of blades are configured to fold in unison toward the central axis of the hub;
a pitch control stage configured to automatically adjust a pitch angle of each blade such that a surface area of the blade exposed to oncoming wind increases with an increase in the oncoming wind, the pitch control stage including:
a blade pitch control slot associated with each blade, the blade pitch control slot configured to determine a limit whereby each blade may extend along the axis parallel to the length of the blade and a limit whereby each blade may rotate about the axis parallel to the length of the blade;
a blade pitch guide operatively coupled to the blade pitch control slot, the blade pitch guide configured to control the pitch angle of each blade based on the blade pitch control slot; and
a blade pitch spring operatively coupled to each blade, the blade pitch spring configured to bias the extension of each blade; and
a blade folding stage comprising at least three mechanical pivot points associated with a folding of each blade, the blade folding stage configured to automatically fold each blade in unison toward the central axis of the hub based on a wind force applied to the plurality of blades, the blade folding stage, including:
a plurality of tie rods, each tie rod mechanically coupled to each blade, each tie rod providing at least two of the three mechanical pivot points associated with the folding of each blade;
a collar assembly mechanically coupled to each tie rod, the collar assembly configured to control the folding of each blade, and further configured to fold each blade in unison, based on each tie rod;
a shaft spring operatively coupled to the collar assembly, the shaft spring configured to bias the folding of the plurality of blades; and
one or more linear bearings operatively coupled to the collar assembly,
wherein the pitch control stage and the blade folding stage operate concurrently to regulate a speed of the wind turbine such that the speed is substantially constant.
